(19) United States
(12) Patent Application Publication
(10) Pub. No.: US 2015/0109769 A1
(43) Pub. Date: Apr. 23, 2015

(54) ANGLE-ADJUSTABLE LIGHTING DEVICE

(71) Applicant: Hsi-Ming Chang, New Taipei City (TW)

(72) Inventor: Hsi-Ming Chang, New Taipei City (TW)

(21) Appl. No.: 14/058,292

(22) Filed: Oct. 21, 2013

(51) Int. Cl. F21L 4/00

(52) U.S. Cl. CPC F21L 4/00
USPC 362/191

(57) ABSTRACT

An angle-adjustable lighting device includes a mounting device including a mounting base formed integral with or affixed to a pair of goggles, engineering cap, face shield or headphone and a plurality of arched retaining bars equiangularly spaced around the periphery of the mounting base and obliquely forwardly extending in direction toward each other, and a lighting device including a battery-operated LED, a switch operable to turn on/off the battery-operated LED and a rod member located at one lateral side thereof and terminating in a coupling ball that is detachably coupled to the arched retaining bars of the mounting device.

### BACKGROUND OF THE INVENTION

(1) Field of the Invention

The present invention relates to lighting technology, and more particularly, to an angle-adjustable lighting device that can be affixed to a pair of goggles, engineering cap, face shield or headphone and freely adjusted to any desired illuminating angle.

(2) Description of the Prior Art

When a person wears a pair of goggles, engineering cap, face shield or headphone to work at night or in a dark environment, an additional lighting device is necessary. However, it is inconvenient to hold a lighting device for illumination during working. Clip-equipped lighting devices are commercially available. By means of the provided clip, a clip-equipped lighting device can be secured to a particular object. However, these commercial clip-equipped lighting devices have a narrow range of applications and do not allow free adjustment of the illuminating angle.

### SUMMARY OF THE INVENTION

The present invention has been accomplished under the circumstances in view. It is therefore, the main object of the present invention to provide an angle-adjustable lighting device that can be affixed to a pair of goggles, engineering cap, face shield or headphone and freely adjusted to any desired illuminating angle.

To achieve this and other objects of the present invention, an angle-adjustable lighting device comprises a mounting device that comprises a mounting base formed integral with or affixed to a pair of goggles, engineering cap, face shield or headphone and a plurality of arched retaining bars equiangularly spaced around the periphery of the mounting base and obliquely forwardly extending in direction toward each other, and a lighting device that comprises a battery-operated LED, a switch operable to turn on/off the battery-operated LED and a rod member located at one lateral side thereof and terminating in a coupling ball that is detachably coupled to the arched retaining bars of the mounting device.

### BRIEF DESCRIPTION OF THE DRAWINGS

FIG. 1 is an exploded view of an angle-adjustable lighting device in accordance with the present invention.

FIG. 2 is an assembly view of the angle-adjustable lighting device in accordance with the present invention.

FIG. 3 illustrates a first application example of the angle-adjustable lighting device in accordance with the present invention.

FIG. 4 illustrates a second application example of the angle-adjustable lighting device in accordance with the present invention.

FIG. 5 illustrates a third application example of the angle-adjustable lighting device in accordance with the present invention.

FIG. 6 illustrates a fourth application example of the angle-adjustable lighting device in accordance with the present invention.

FIG. 7 illustrates a fifth application example of the angle-adjustable lighting device in accordance with the present invention.

FIG. 8 illustrates a sixth application example of the angle-adjustable lighting device in accordance with the present invention.

### DETAILED DESCRIPTION OF THE PREFERRED EMBODIMENT

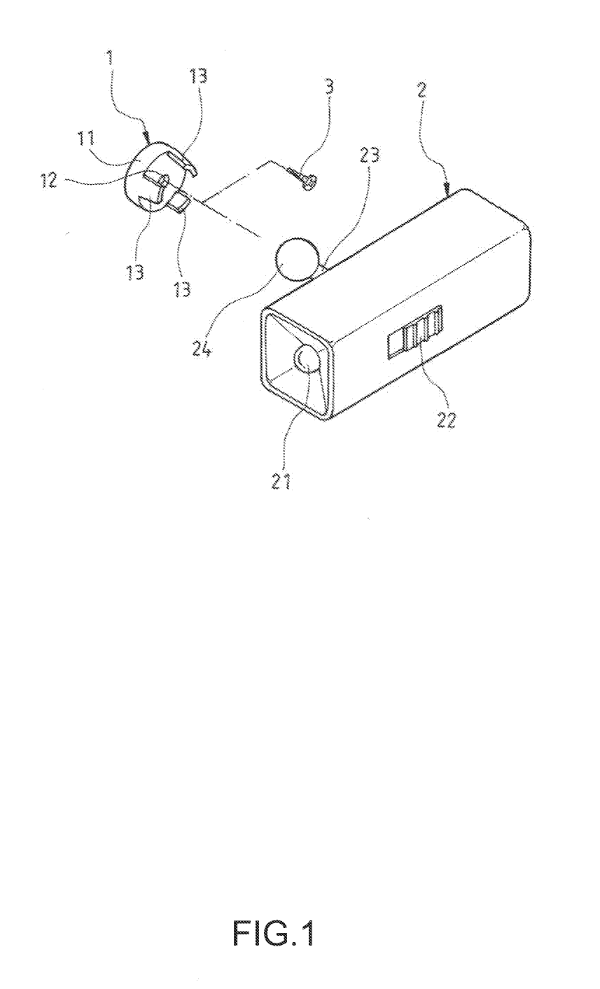

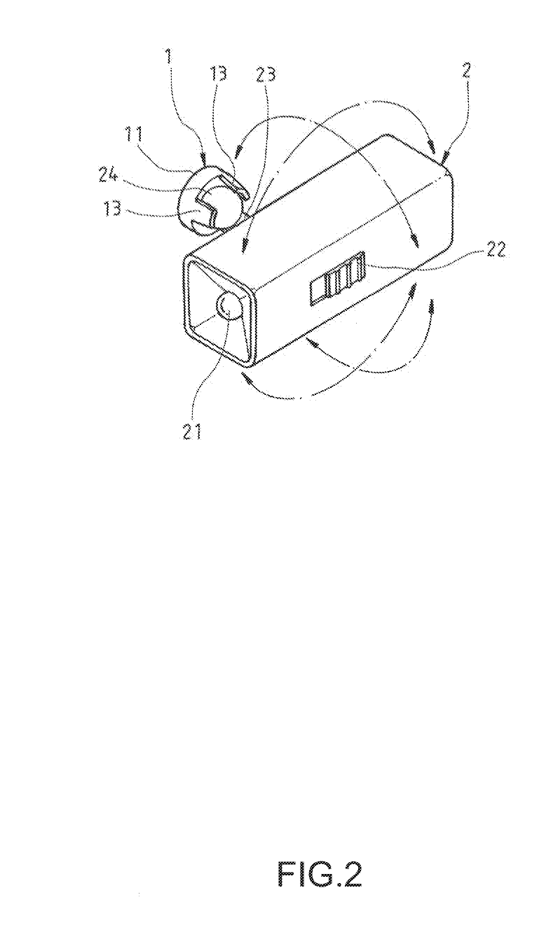

Referring to FIGS. 1 and 2, an angle-adjustable lighting device in accordance with the present invention is shown. The angle-adjustable lighting device comprises a mounting device 1 and a lighting device 2.

The mounting device 1 is made in the form of a ball socket comprising a mounting base 11, a mounting through hole 12 located at the center of the mounting base 11, and a plurality of arched retaining bars 13 equiangularly spaced around the periphery of the mounting base 11 and forwardly extended from the periphery of the mounting base 11 in direction toward the imaginary axis that passes through the mounting through hole 12. The lighting device 2 comprises a battery-operated LED 21, a switch 22 operable to turn on/off the battery-operated LED 21, a rod member 23 located at one lateral side thereof and terminating in a coupling ball 24 that can be coupled to the arched retaining bars 13 of the mounting device 1.

The mounting device 1 can be formed integral with a part of an external object (goggles, engineering cap, face shield, headphone, etc.). Alternatively, a screw 3 can be mounted in the mounting through hole 12 of the mounting base 11 of the mounting device 1 to affix the mounting device 1 to an external object. An adhesive can also be used to bond the mounting base 11 of the mounting device 1 to an external object. Thereafter, insert the coupling ball 24 of the lighting device 2 into the space in the mounting device 1 around the arched retaining bars 13, enabling the coupling ball 24 of the lighting device 2 to be rotatably adjustably secured to the mounting device 1 by the arched retaining bars 13. Subject to the configuration and elastic material property of the arched retaining bars 13, the lighting device 2 is secured to the mounting device 1 and can be adjusted to any desired angle relative to the mounting device 1.

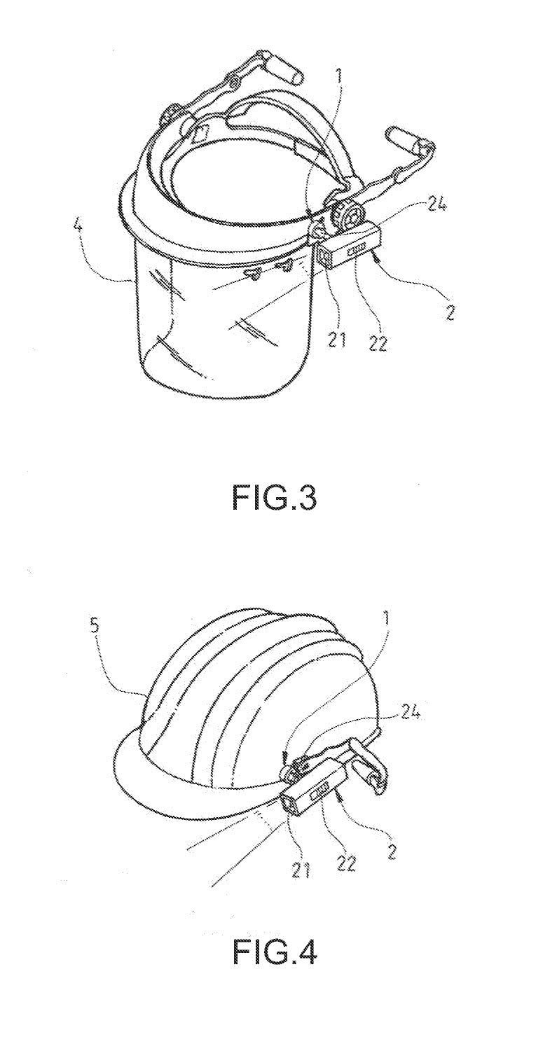

Referring to FIG. 3, in one application example of the present invention, the mounting device 1 is formed integral with (or affixed to) a face shield 4 to secure the lighting device 2 to the face shield 4 for illumination.

Referring to FIG. 4, in another application example of the present invention, the mounting device 1 is formed integral with (or affixed to) an engineering cap 5 to secure the lighting device 2 to the engineering cap 5 for illumination.

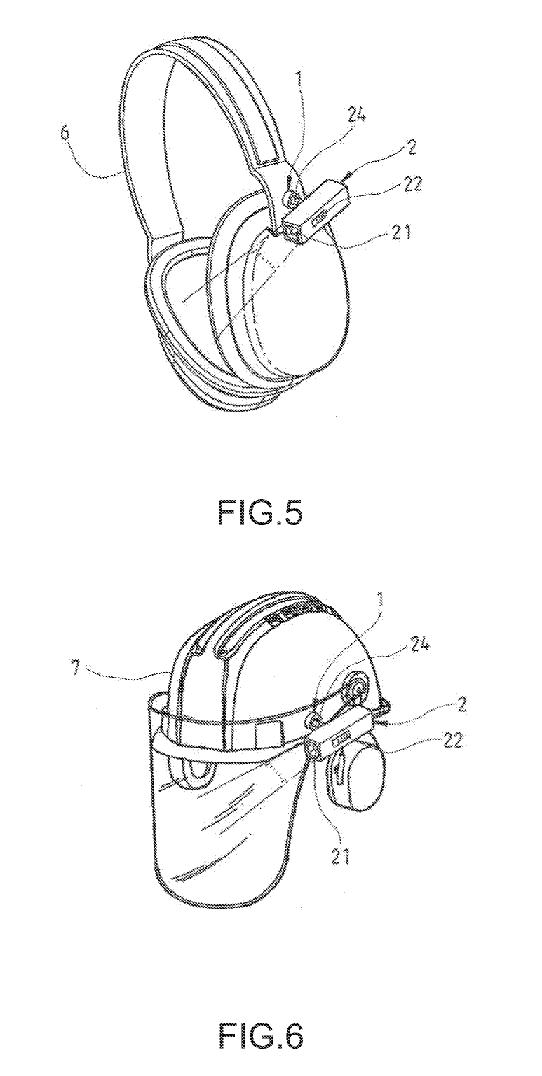

Referring to FIG. 5, in still another application example of the present invention, the mounting device 1 is formed integral with (or affixed to) a headphone 6 to secure the lighting device 2 to the headphone 6 for illumination.

Referring to FIG. 6, in still another application example of the present invention, the mounting device 1 is formed integral with (or affixed to) a face shield-attached engineering cap 7 to secure the lighting device 2 to the face shield-attached engineering cap 7 for illumination.

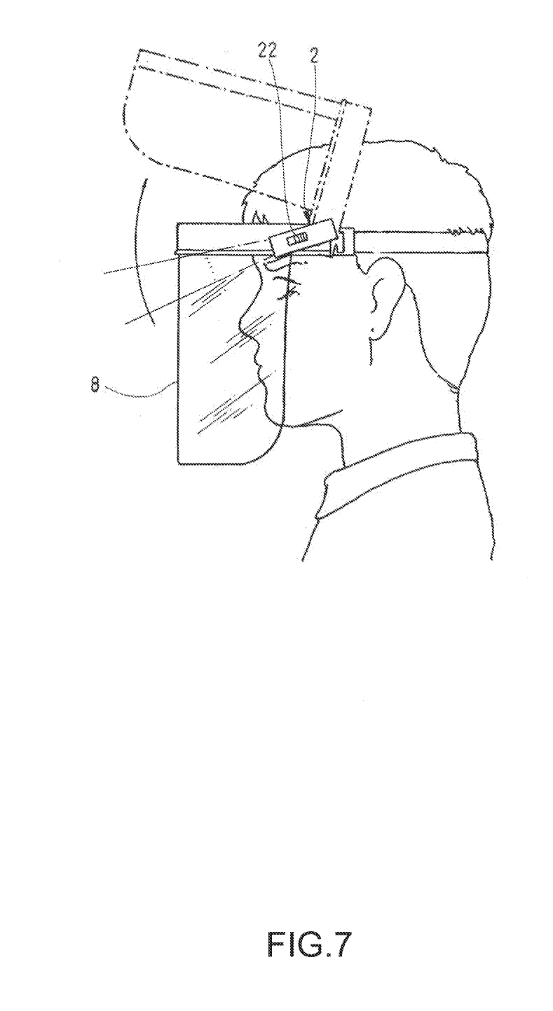

Referring to FIG. 7, in still another application example of the present invention, the mounting device 1 is formed integral with (or affixed to) another face shield 8 to secure the lighting device 2 to the face shield 8 for illumination.

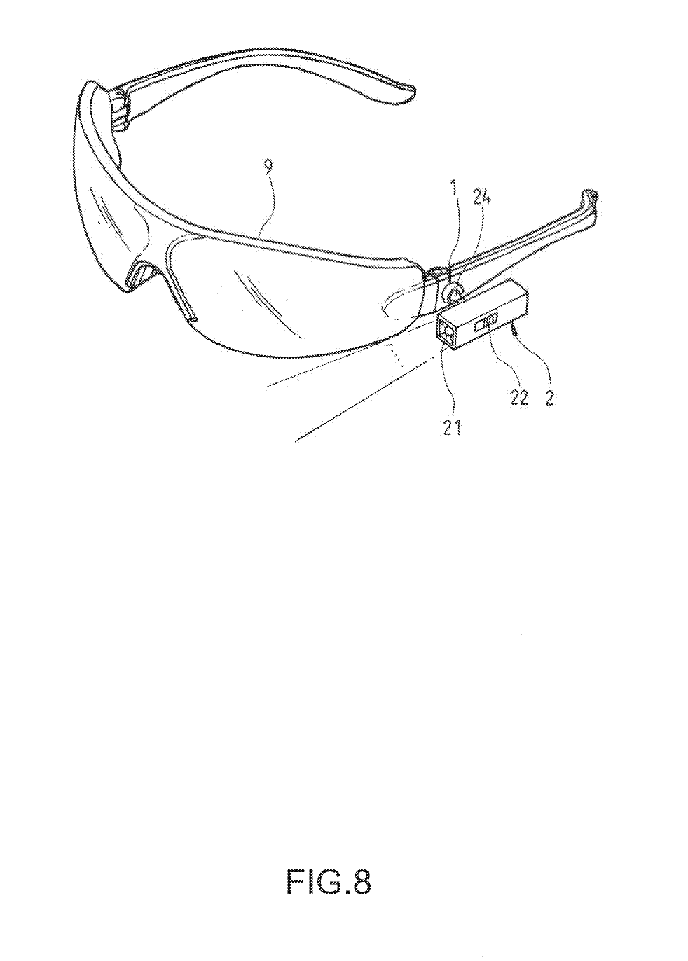

Referring to FIG. 8, in still another application example of the present invention, the mounting device 1 is formed integral with (or affixed to) a pair of goggles 9 to secure the lighting device 2 to the pair of goggles 8 for illumination.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. An angle-adjustable lighting device, comprising:
a mounting device made in the form of a ball socket and mountable to a pair of goggles, engineering cap, face shield or headphone, said mounting device comprising a mounting base, and a plurality of arched retaining bars equiangularly spaced around the periphery of said mounting base; and a lighting device comprising a battery-operated light-emitting diode, a switch operable to turn on/off said battery-operated light-emitting device, and a rod member located at one lateral side thereof and terminating in a coupling ball detachably coupled to said arched retaining bars of said mounting device.

2. The angle-adjustable lighting device as claimed in claim 1, wherein said mounting device comprises a mounting through hole located at the center of said mounting base for the mounting of a screw to affix said mounting device to an external object.

3. The angle-adjustable lighting device as claimed in claim 1, wherein said arched retaining bars are equiangularly spaced around the periphery of said mounting base and forwardly obliquely extended from the periphery of said mounting base in direction toward each other.

4. The angle-adjustable lighting device as claimed in claim 1, wherein said mounting base of said mounting device is formed integral with an object.

5. The angle-adjustable lighting device as claimed in claim 1, wherein said mounting base of said mounting device is bonded to an external object with an adhesive.
